(19) United States
(12) Patent Application Publication
(10) Pub. No.: US 2024/0344590 A1
(43) Pub. Date: Oct. 17, 2024

(54) Torsional Vibration Damper

(71) Applicant: Hasse & Wrede GmbH, Berlin (DE)

(72) Inventors: Michael STEIDL, Berlin (DE); Stephan BOHMEYER, Hoppegarten (DE); Norbert REINSPERGER, Hoppegarten (DE); Sebastian WILLEKE, Hoppegarten (DE)

(21) Appl. No.: 18/631,223

(22) Filed: Apr. 10, 2024

(30) Foreign Application Priority Data
Apr. 11, 2023 (DE) 10 2023 109 103.4

(51) Int. Cl. F16F 15/16; F16F 15/167

(52) U.S. Cl. CPC F16F 15/165; F16F 15/167; F16F 2222/08; F16F 2224/0208; F16F 2224/025; F16F 2226/045; F16F 2226/048; F16F 2230/30; F16F 2232/02; F16F 2236/08

(57) ABSTRACT

A torsional vibration damper has a hub part (primary mass) which can be fastened on a drive shaft of an engine and a flywheel ring (secondary mass) which surrounds the hub part in the radially outer region, wherein a gap filled with a fluid and one or more sealing devices are provided between the hub part and the flywheel ring, by which escape of fluid is to be prevented. The sealing devices each have a first ring, which is tightly connected to the hub part, as well as a second ring, which is tightly connected to the flywheel ring, as well as a sealing element made of a plastic material. The respective sealing element is connected in a material-locking manner to fastening sections on a respective outer axial side of the first and second ring. The sealing element has at least one elastically deformable axial projection in the region of each of the fastening sections.

### CROSS REFERENCE TO RELATED APPLICATION

This application claims priority under 35 U.S.C. § 119 from German Patent Application No. 10 2023 109 103.4, filed Apr. 11, 2023, the entire disclosure of which is herein expressly incorporated by reference.

### BACKGROUND AND SUMMARY

The present invention relates to a torsional vibration damper having a hub part which is fastened on a drive shaft of an engine, and a flywheel ring which surrounds the hub part in a radially outer region, wherein a gap provided between the hub part and the flywheel ring is filled with fluid.

A generic torsional vibration damper is known from DE 10 2020 118 066 A1.

GB 11 05 292 A and WO2018/019729 A1 are also cited for the technological background.

The torsional vibration dampers of this type have an outwardly offset flywheel

ring, which distinguishes their design from constructions in which the flywheel ring is completely encapsulated in a separate housing.

DE 10 2020 119 066 A1 then shows torsional vibration dampers with a hub part that can be attached to a drive shaft of a motor and a flywheel ring that surrounds the hub part in the radially outer area. A gap filled with a fluid and at least one sealing device is arranged between the hub part and the flywheel ring, by means of which the leakage of the fluid is to be prevented.

The sealing devices each have a first ring that is tightly connected to the hub part, hereinafter referred to as the inner ring, and a second ring that is tightly connected to the flywheel ring, hereinafter referred to as the outer ring. Furthermore, each sealing device has a sealing element made of an elastomer, which is sealingly connected to the inner ring on the one hand and to the outer ring on the other.

With this arrangement, DE 10 2020 118 066 A1 solves the task of further developing a torsional vibration damper in such a way that the space between the rings is not impaired or reduced by the sealing elements. This results in a further advantage of achieving greater moments of inertia of the flywheel ring. In addition, it is not necessary to provide the flywheel ring with recesses in the area of the sealing element. The sealing element is welded at different heights.

However, the sealing element of DE 10 2020 118 066 A1 must be welded at different heights. This is done by pressing on. The system of the torsional vibration damper is statically overdetermined, so that the inner ring must be welded to the hub and the outer ring to the flywheel ring independently of each other.

The present invention therefore addresses the task of creating a torsional vibration damper with a structure comparable to DE 10 2020 118 066 A1, which is at the same time simpler to manufacture, in particular with simple welding devices and preferably in a single manufacturing step.

The invention solves this problem by providing a torsional vibration damper with the features of the independent claims.

A torsional vibration damper according to the invention has a hub part, which can be attached to a drive shaft of an engine, as the primary mass and a flywheel ring, which surrounds the hub part in the radially outer area, as the secondary mass.

There is a gap filled with a fluid between the hub part and the flywheel ring. To prevent the fluid from escaping, one or more sealing devices are also provided.

The sealing device(s) each have a first ring that is tightly connected to the hub part and a second ring that is tightly connected to the flywheel ring.

Furthermore, the sealing device(s) each have a sealing element made of a plastic, preferably rubber, particularly preferably an elastomer or a TPE, which is connected to the first ring in a sealing manner on the one hand and to the second ring on the other.

The respective sealing element is connected to fastening sections on a respective outer axial side of the first and second ring in a material-locking manner.

The first and second rings of the sealing device are in turn connected to the hub part and the flywheel ring in a material-locking manner.

To ensure a wide-area material seal, the rings of the sealing device must be pressed against the metal surface when joining. However, the contact surfaces for pressing are subject to tolerances and therefore vary in height, so that the contact pressure can act unevenly. To compensate for this, the sealing element has at least one elastically deformable axial projection in the area of each of the fastening sections.

This compensates for the undefined height difference of the fastening areas and the associated manufacturing tolerances when connecting the sealing device to the other elements of the damper, in particular the flywheel ring and the hub part.

Advantageous embodiments of the invention are the subject of the dependent claims.

The axial protrusion can be designed as a ring-shaped circumferential material bead. This enables particularly good force distribution during pressing. Alternatively, a plurality of axial projections arranged on a circular path can be arranged in each of the fastening sections to increase elasticity.

The axial protrusion or protrusions can have a rectangular cross-section with rounded edges in order to provide particularly wide bearing surfaces for a pressing device.

For optimum height compensation, the sealing element can have a wall thickness in the area of the axial protrusions that is at least 50% thicker than the immediately adjacent areas. Particularly preferably, the sealing element can have a wall thickness in the area of the axial protrusions that is increased by 70-150% compared to the immediately adjacent areas.

The sealing element with the axial projections can be designed as a single piece, preferably monolithic, in particular seamless, i.e. free of connecting seams such as those that occur during welding or gluing. This ensures an even distribution of force, particularly in the case of oblique forces.

The sealing element can advantageously be made of an elastomer or TPE, a thermoplastic elastomer. These are particularly stable against the liquid in the annular gap, which is usually an inorganic oil. Preferably, the sealing element is made of a high-temperature-capable elastomer, e.g. a silicone material, or of a high-temperature-capable TPE. High-temperature capability refers to the dimensional stability of the sealing element at temperatures of more than 130° C., preferably more than 220° C. While thermoplastics, for example, can deform plastically from 80° C. depending on their composition, the elastomers used according to the invention or the TPE used according to the invention remain dimensionally stable and thus elastically deformable under the aforementioned application conditions.

The plastic sealing element(s) of the sealing device can be sealingly connected to the metal rings attached to the hub part or the flywheel ring by a rubber-to-metal bond produced during an elastomer crosslinking process. This elastomer cross-linking process also includes vulcanization.

The sealing device or devices are connected, in particular welded, to the hub part and the flywheel ring via the metal rings. The sealing element is connected to the rings in a material-locking manner, in particular vulcanized on.

The welded joint preferably has at least one annular weld seam, which in particular runs coaxially to the flywheel ring and the hub part.

In particular, the sealing element can consist of an inorganically filled silicone elastomer. This material has proven to be particularly ideal for sealing inorganic oils.

Each of the axial projections can each have a bearing surface for supporting a pressure device, which bearing surfaces are axially offset, or offset in height, and parallel to each other.

Also according to the invention is a method for producing a torsional vibration damper as described above, wherein the respective sealing device is connected in a material-locking manner via the first and second ring to the hub part and the flywheel ring of the damping oscillator using the following method steps:
a) pressing the sealing device, whereby the metal surface of the first and/or the second ring is pressed against the hub part and the flywheel ring by means of a pressing device;
b) material-locking connection between the rings of the sealing device and the hub part and the flywheel ring by welding, preferably by electron beam welding, particularly preferably under vacuum.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic sectional view of a torsional vibration damper according to an embodiment of the invention;

FIG. 2 is a schematic front view of a cover of the torsional vibration damper as shown in FIG. 1;

FIG. 3 is a schematic sectional view of the lid according to FIG. 2; and

FIG. 4 is a schematic partial sectional view of a torsional vibration damper according to the state of the art;

### DETAILED DESCRIPTION OF THE DRAWINGS

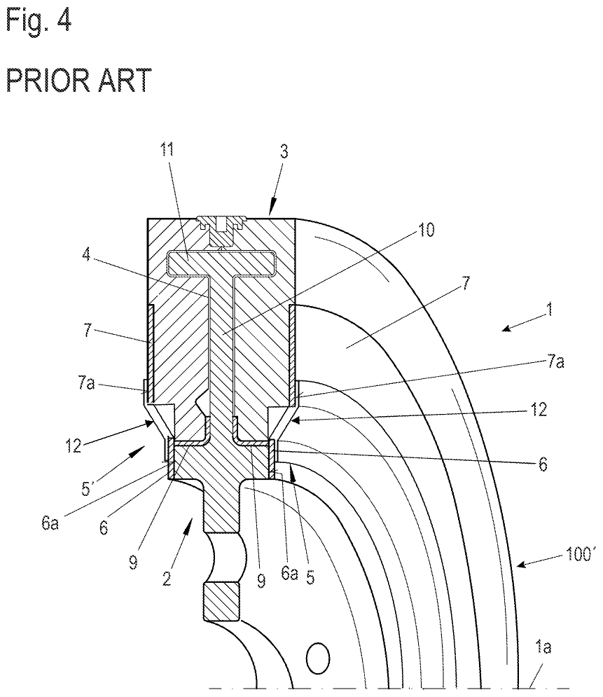

FIG. 4 shows a torsional vibration damper 1 from the state of the art, which document DE 10 2020 118 066 A1, to which reference is made here, describes in detail with the structure and function of the torsional vibration damper.

The torsional vibration damper with an axis of rotation 1a comprises a hub part 2 (primary mass) which can be attached to a drive shaft of an engine, a fly-wheel ring 3 (secondary mass) which surrounds the hub part 2 in the radially outer region, a gap 4 being provided between the hub part 2 and the flywheel ring 3, which gap 4 is filled with a fluid, preferably a silicone oil, and sealing devices 5′ for sealing the gap 4 to the outside. This is an external flywheel ring 3.

Each sealing device 5′ has a first ring 6, which is tightly connected to the hub part 2, and a second ring 7, which is also tightly connected to the flywheel ring 3, as well as a sealing element 12 made of an elastomer or a TPE, which is connected to the first ring 6 in a sealing manner on the one hand and to the second ring 7 in a sealing manner on the other.

The rings 6, 7 are preferably made of metal and are firmly and tightly connected to the hub part 2 or the flywheel ring 3 by a suitable connection method, in particular screwing, welding, gluing, soldering or the like.

The respective sealing element 12 made of elastomer or TPE, preferably of high-temperature-capable elastomer, e.g. silicone material, or high-temperature-capable TPE, is connected to the two first and second rings 6, 7 in the manner of a composite part in a circumferentially sealing manner. This connection can be realized by a rubber-metal connection produced in particular during an elastomer cross-linking process. Alternatively, or additionally, a welding process can be used.

The ring 6, ring 7 and the sealing element 12 form an assembly as a sealing device, which is also referred to as the cover 100′. The torsional vibration damper 1 has two covers 100′.

The flywheel ring 3 is mounted here on plain bearings 9 in relation to the hub part 2, both radially and axially, whereby the size of the gap 4 is precisely defined.

The flywheel ring 3 preferably consists of two components in order to be able to mount this flywheel ring 3 on the hub part 2. All previously known designs and others are also possible.

In the embodiments shown, the hub part 2 is provided with a radially outwardly projecting flange 10, which is closed off in the outer edge area by a web 11 extending in the axial direction, which can extend to both sides of the flange 10, resulting in a T-shape, but can also extend to only one side of the flange 10, resulting in an L-shaped cross-section. Due to this geometry, the flywheel ring 3 is fixed relative to the hub part 2 both in the radial direction and in the axial direction, whereby, as already mentioned, the size of the circumferential gap 4 is always defined by the plain bearings 9.

The ring-shaped sealing element 12, made of elastomer or TPE, is simultaneously vulcanized onto larger-surface, external axial and radial edge areas 6a, 7a of the rings 6 and 7. The edge areas 6a, 7a are therefore fastening surfaces for the sealing element 12. This is described in more detail below.

Each sealing device 5′ also consists of the first ring 6, which is tightly connected to the hub part 2, the second ring 7, which is also tightly connected to the flywheel ring 3, and the ring-shaped sealing element 12 made of an elastomer or TEP, which is connected to the first ring 6 in a sealing manner on the one hand and to the second ring 7 in a sealing manner on the other.

The first ring 6 and the second ring 7 of a respective sealing device 5′ do not overlap in the radial direction. The outer diameter of the first ring 6 is smaller than the inner diameter of the second ring 7.

The first and second rings 6, 7 of the respective sealing device 5′ are arranged here in axially spaced planes.

This results in a perfect and permanent seal of the gap area, whereby the use of elastomers suitable for high temperatures, e.g. silicone material or corresponding TPE materials for the respective ring-shaped sealing elements 12 has the advantage that these are also suitable in high temperature ranges.

It is particularly advantageous that the ring-shaped sealing element 12 made of an elastomer, preferably silicone, or of a TPE is vulcanized to the edge regions 6a, 7a of the staggered outer axial surfaces and opposing radial surfaces of the first and second rings 6, 7. This is described further below.

The term “staggered” means that these outer axial surfaces or their edge regions 6a, 7a are arranged one above the other in the radial direction and both point in the same direction, namely outwards, whereby an inner diameter of the edge region 7a of the second ring 7 is larger than an outer diameter of the first ring 6.

The flywheel ring 3 is advantageously mounted on plain bearings 9 in relation to the hub part 2, both radially and axially, whereby the size of the gap 4 is precisely defined.

In this way, covers 100′ of the torsional vibration damper 1 are formed, which each have the first ring 6, the second ring 7 and the sealing element 12.

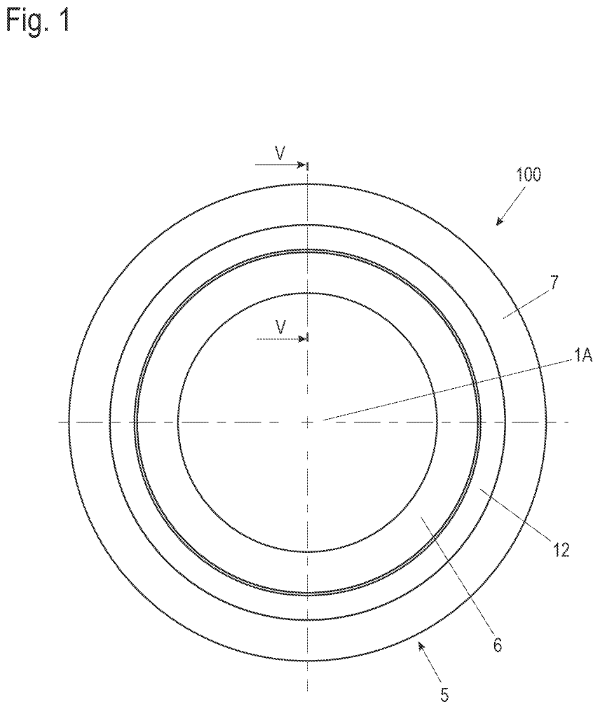

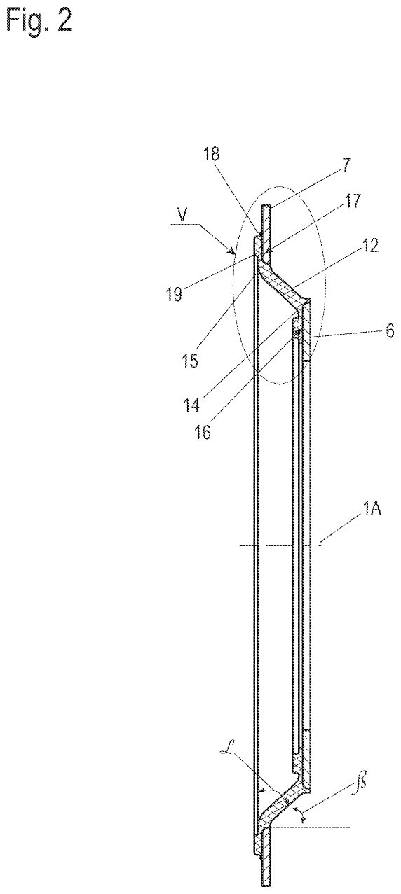

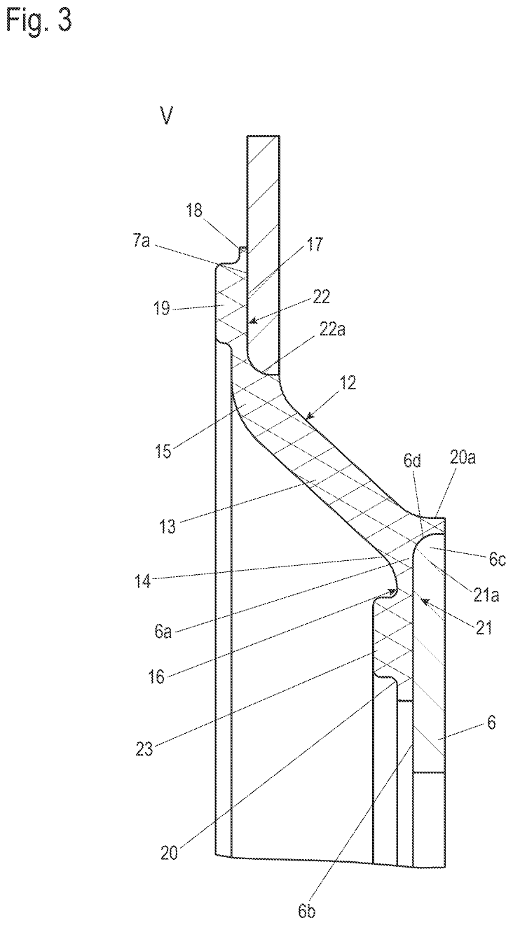

FIG. 1 shows a schematic front view of a cover 100 of a torsional vibration damper 1 according to an embodiment of the invention. FIG. 2 shows a schematic sectional view of the cover 100 according to FIG. 1. An enlarged view of the area V-V of the cover 100 according to FIG. 1 and the area V in FIG. 2 is shown in FIG. 3.

Identical elements to FIG. 4 are marked with identical reference signs.

One edge of the outer diameter of the first ring 6 is arranged at a radial distance and at an axial distance from an edge of the inner diameter of the second ring 7.

A sealing section 13 of the respective ring-shaped sealing element 12 runs at an overall angle to the radial and axial direction and adheres to both the outer axial sides and the radial sides of the respective rings 6, 7.

The term “oblique to the radial direction and to the axial direction” means that the sealing section 13 extends at an angle α to the radial direction, which is perpendicular to the axial direction of the axis of rotation 1a, and at an angle β to the axial direction of the axis of rotation 1a.

The outer axial sides of the respective rings 6, 7 have the edge areas 6a and 7a.

The term “external axial sides” means the respective sides or lateral surfaces of the rings 6, 7 of both sealing devices 5, which point outwards, thus facing away from the flywheel ring 3 and, in contrast to internal sides, are not connected to either the flywheel ring 3 or the hub part 2.

The term “radial sides” refers to the respective circumferential radial lateral surfaces with the associated diameter of the respective ring 6, 7. The rings 6, 7 each form a cylindrical annular disk with a circular cross-section with an outer diameter and an inner diameter.

It is advantageous that the two rings 6, 7, i.e. the two metal rings of the sealing devices 5, have different diameters (inside and outside) and that the sealing element 12, which is designed as a plastic ring, runs axially in the manner of a plastic track at the angle β, the value of which is between 15 and 50°. The associated angle α to the radial direction then has the value α=90°−β.

This results in very good durability of the sealing element 12 under heavy mechanical stress. The influence of the material of the sealing element 12 on the service life of the silicone oil in the gap 4 is low. In addition, the resistance of the material of the sealing element 12 to the silicone oil over the service life of the damper is also low (low swelling).

The sealing element 12 comprises the circumferential sealing section 13 with transition sections 14, 15 and fastening sections 16, 17. This can best be seen in the enlarged illustration in FIG. 3.

At its lower end, the sealing section 13 is connected to the first fastening section 16 by the concave (in relation to the outside) transition section 14. The fastening section 16 has a circumferential recess 21 facing away from the second ring 7, which is axially limited by a circumferential projection 20 extending in the radial direction and radially limited by a further circumferential projection 20a extending in the axial direction.

The sealing element 12 is vulcanized with the first fastening section 16 to the axial side and the radial side of the outer diameter of the first ring 6 in such a way that the recess 21 surrounds the outer edge of the first ring 6. The fastening section 17 with the radial projection 20 is connected to the edge area 6a of the first ring 6 and the axial projection 20a is connected to the lateral surface 6d of the outer diameter of the first ring 6.

A rounding 6c of the edge between the edge area 6a and the lateral surface 6d of the first ring 6 is tightly surrounded by a corresponding section in the form of a groove 21a of the recess 21 of the sealing element 12.

Similarly, the sealing section 13 is connected to the second fastening section 17 at its upper end by the convex transition section 15. The fastening section 17 has a recess 22 facing the second ring 7, which is axially limited by a projection 18 extending in the radial direction and radially limited by a circumferential groove 22a.

The sealing element 12 is vulcanized to the second fastening section 17 on the axial side and the radial side of the inner diameter of the second ring 7 in such a way that the recess 22 surrounds the inner edge of the second ring 7. The fastening section 17 with the radial projection 18 is connected to the edge area 7a of the second ring 7 and the groove 22a is connected to the lateral sur-face 7d of the inner diameter of the second ring 7. A rounding 7b of the edge between the edge region 7a and the lateral surface 7d of the second ring 7 is tightly surrounded by the corresponding chamfer 22a of the recess 22a of the sealing element 12.

The fastening section 17 here has an axial projection which protrudes outwards from the fastening section 17. This projection is referred to here as axial projection 19 and is rectangular in cross-section with rounded edges. On the one hand, this integrated axial projection 19 prevents damage to the sealing element 12 during the construction of the torsional vibration damper 1, transportation and assembly. On the other hand, the shape and tolerance compensation serves for a pressing device, which is used during fastening to achieve optimum contact at the interface between the two metal surfaces of the respective ring of the damping device with the flywheel ring or the hub part, in particular by welding.

The sealing element 12 can be attached to the respective ring 6 or 7 by vulcanization.

The shaping and design of the axial projection 19, which extends axially outwards in relation to the axis of rotation 1a, is particularly simple in the form of an annular circumferential bead. However, since the axial projection 19 should be designed to be elastically deformable when the metal surfaces are welded under pressure by a pressure device, the axial projection can preferably also be a plurality of projections, e.g. point projections, arranged circumferentially distributed on a circular path.

In contrast to the prior art, the sealing element also has an axial projection 23 in the area of the fastening section 16, at which the first ring 6 is connected to the sealing element 12. The axial projections 19 and 23 are arranged at different levels in the axial direction.

As can be seen in FIG. 1-4, the sealing element 12 is welded at different heights, with the inner ring having a different height than the outer ring. The sealing rings must be pressed together for welding. The overall system is statically overdetermined. This means that long tolerance chains can lead to quite large deviations in the actual position between the internal and external target positions. It is therefore advantageous to design the device in such a way that it presses the inner and outer ring independently of each other and in a force-controlled manner. With the invention, the difference in height is compensated for by the elastically deformable axial projections in both fastening areas 16 and 17 of the rings, so that a favorable, rigid and displacement-controlled and/or force-controlled pressing device can be used in production.

In particular, an elastic bead can also be applied in the axial direction in both fastening areas 16 and 17 during vulcanization. This can be compressed by the pressing device so that the shape and position tolerances are compensated.

The rings can then be welded to the other components of the torsional vibration damper. Particularly preferably, the sealing element 12 has a wall thickness in the area of the axial projections 19 and 23 that is at least 50% thicker than in the immediately adjacent areas. Particularly preferably, the wall thickness can be increased by 70-150% compared to the aforementioned neighboring areas.

In particular, a one-piece pressing device can be used to weld the rings, which can be controlled away during the pressing process, since all tolerances can be compensated for by the axial projections of an elastic material, such as rubber, according to the invention. Without the rings and the axial projections, a two-piece pressing device would be required, whereby the inner and outer rings would have to be pressed on in a force-controlled manner, which is more complicated, more expensive and, depending on the transmission ratio, also more time-consuming to manufacture.

The combination of the axial protrusions and the weldable rings is therefore particularly advantageous for the production of the sealing device with the sealing element and for the production of the rotary oscillator as a whole.

The sealing element 12 with the axial protrusions is made in one piece, in particular monolithic or seamless.

As can be seen from FIGS. 2-3, each of the axial projections 19 and 23 each has a bearing surface 24 and 25 for supporting a pressure device, which are formed parallel to one another. The bearing surfaces 24 and 25 are arranged offset in height to one another on different planes along the axis of rotation 1a

Welding can preferably be carried out by beam welding, especially electron beam welding, particularly preferably under vacuum.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SYMBOLS

1, 1′ Torsional vibration damper
1A Rotary axis
2 Hub part
2a Fixing surface
2b Margin
3 Flywheel
3a Ind section
3b Margin
3c Fixing surface
4 Gap
5 Scaling device
6 Ring
6a Edge area
6b Fixing surface
6c Rounding
6d Sheathing area
7 Ring
7a Edge area
7b Rounding
7c Sheathing area
8 Ring
9 Plain bearing
10 Flange
11 Jetty
12 Scaling element
13 Scaling section
14, 15 Transition section
16, 17 Fixing section
18 Overhang
19 Axial projection
20 Overhang
21, 22 Recess
21a, 22a Hollow groove
100, 100′ lid
23 Axial projection
24, 25 Storage area
α, β angles

What is claimed is:

1. A torsional vibration damper, comprising:
a hub part which is fastenable on a drive shaft of an engine;
a flywheel ring which surrounds the hub part in a radially outer region, wherein a gap provided between the hub part and the flywheel ring is filled with a fluid; and
one or more sealing devices configured to prevent the fluid from escaping, wherein each sealing device comprises:
a first ring sealingly connected to the hub part,
a second ring sealingly connected to the flywheel ring, and
a sealing element made of a plastic material, which is sealingly connected to the first ring on the one hand and to the second ring on the other hand,
wherein the sealing element is connected in a material-locking manner to fastening sections on a respective outer axial side of the first and second ring, and
wherein the sealing element has at least one elastically deformable axial projection in a region of each of the fastening sections.

2. The torsional vibration damper according to claim 1, wherein
the axial projection is configured as an annular circumferential material bead, or
the axial projection comprises a plurality of axial projections arranged on a circular path in each of the fastening sections.

3. The torsional vibration damper according to claim 2, wherein
the axial projection or projections have a rectangular cross-section with rounded edges.

4. The torsional vibration damper according to claim 1, wherein
the sealing element has a wall thickness in the region of the at least one axial projection that is at least 50% greater than in immediately adjacent regions.

5. The torsional vibration damper according to claim 1, wherein
the sealing element has a wall thickness in the region of the at least one axial projection which is increased by 70-150% compared to immediately adjacent regions.

6. The torsional vibration damper according to claim 1, wherein
the sealing element is formed in one piece with the at least one axial projection.

7. The torsional vibration damper according to claim 1, wherein
the sealing element is formed in one piece monolithically with the at least one axial projection.

8. The torsional vibration damper according to claim 1, wherein
the sealing element is made of elastomer or TPE.

9. The torsional vibration damper according to claim 8, wherein the sealing element consists essentially of a high-temperature-capable elastomer or of a high-temperature-capable TPE,
wherein high-temperature capability refers to a dimensional stability of the sealing element at temperatures of more than 130° C.

10. The torsional vibration damper according to claim 8, wherein the sealing device has the first and second rings made of metal and fastened respectively to the hub part and to the flywheel ring by a welded connection.

11. The torsional vibration damper according to claim 10, wherein the welded connection has at least one annular weld seam.

12. The torsional vibration damper according to claim 1, wherein
the sealing element consists essentially of an inorganically filled silicone elastomer, wherein a proportion of inorganic material is at least 30%.

13. The torsional vibration damper according to claim 1, wherein
each of the axial projections has a respective bearing surface for supporting a pressing surface of a pressing device, which bearing surfaces are axially offset and parallel to one another.

14. A method for manufacturing a torsional vibration damper having a hub part which is fastenable on a drive shaft of an engine; a flywheel ring which surrounds the hub part in a radially outer region, wherein a gap provided between the hub part and the flywheel ring is filled with a fluid; and one or more sealing devices configured to prevent the fluid from escaping, wherein each sealing device comprises:
a first ring,
a second ring, and
a sealing element made of a plastic material, which is sealingly connected to the first ring on the one hand and to the second ring on the other hand, wherein the sealing element has at least one elastically deformable axial projection in a region of each fastening section of the hub part and the flywheel ring,
wherein the method comprises:
connecting the sealing device to the hub part and the flywheel ring in a material- locking manner by the steps of:
a) pressing a metal surface of the first and/or second ring of the sealing device against the hub part and the flywheel ring by way of a pressing device; and
b) forming a material-locking connection between the sealing device and the hub part and the flywheel ring by welding.

15. The method according to claim 14, wherein the welding is electron beam welding under vacuum.
